(19) United States
(12) Patent Application Publication
(10) Pub. No.: US 2018/0099452 A1
(43) Pub. Date: Apr. 12, 2018

(54) METHOD FOR PRODUCING THREE-DIMENSIONAL OBJECT AND OBJECT

(71) Applicant: MIMAKI ENGINEERING CO., LTD., Nagano (JP)

(72) Inventors: Kazuhiro OCHI, Nagano (JP); Hikaru MUGISHIMA, Nagano (JP); Masakatsu OKAWA, Nagano (JP)

(21) Appl. No.: 15/728,225

(22) Filed: Oct. 9, 2017

(30) Foreign Application Priority Data
Oct. 11, 2016 (JP) 2016-199660

(51) Int. Cl. B29C 64/106; B33Y 10/00

(52) U.S. Cl. CPC B29C 64/106; B33Y 10/00

(57) ABSTRACT

A method for producing a three-dimensional object includes depositing an ink layer over an upper surface of a table so as to form a removal portion with which the three-dimensional object is removed off the upper surface of the table. The ink layer is deposited over a planar upper surface of the removal portion formed in the removal portion forming step so as to form the three-dimensional object over the planar upper surface of the removal portion. The removal portion includes a support material and a mixture material. The support material supports the three-dimensional object. The mixture material is less adhesive to the upper surface of the table than the support material is adhesive to the upper surface of the table.

### CROSS-REFERENCE TO RELATED APPLICATIONS

The present application claims priority under 35 U.S.C. § 119 to Japanese Patent Application No, 2016-199660, filed Oct. 11, 2016. The contents of this application are incorporated herein by reference in their entirety.

### BACKGROUND

### Field of the Invention

The present invention relates to a method for producing a three-dimensional object. The present invention also relates to an object including a predetermined three-dimensional object.

### Discussion of the Background

JP2013-67016A1 discloses a three-dimensional-object forming apparatus that produces a predetermined three-dimensional object. The three-dimensional-object forming apparatus recited in JP2013-67016A1 includes a Z movement unit. The Z movement unit is made up of a transportable plate and a plate mount on which the transportable plate is placed. The upper surface of the transportable plate serves as a build stage. In In the method for producing a three-dimensional object using the three-dimensional-object forming apparatus recited in JP2013-67016A1, a support material is first extruded from an ink-jet head so that a foundation layer made of the support material is formed over the upper surface of the transportable plate. Then, a model material and a support material are extruded from the ink-jet head so that a slice layer made of the model material and the support material is deposited over the foundation layer. Thus, a solid object is formed. Then, the support materials are removed off the object and thus a three-dimensional object is isolated.

In the method for producing a three-dimensional object using the three-dimensional-object forming apparatus recited in JP2013-67016A1, the support material contained in the foundation layer becomes integral to the support material contained in the slice layer. Also, support material constituting foundation layers is, generally, highly adhesive to transportable plates. Therefore, in this method for producing, it is not easy to, after forming a solid object over the foundation layer, remove the three-dimensional object off the foundation layer and remove the foundation layer off the transportable plate. In light of the circumstances, in this method for producing, after a solid object is formed over the foundation layer, the transportable plate with the foundation layer and the three-dimensional object on is removed off the plate mount. Then, the solid object is removed off the transportable plate and immersed in water to dissolve and remove the support material. Alternatively, the transportable plate with the foundation layer and the three-dimensional object on is immersed in water to dissolve and remove the support material and isolate the three-dimensional object.

The contents of JP2013-67016A1 are incorporated herein by reference in their entirety.

In the method for producing a three-dimensional object using the three-dimensional-object forming apparatus recited in JP2013-67016A1, it is necessary to remove the transportable plate off the plate mount. This may make the configuration of the three-dimensional-object forming apparatus complicated. Also in this method for producing, in the configuration in which the transportable plate with the foundation layer and the three-dimensional object on is immersed in water to dissolve and remove the support material, the three-dimensional-object forming apparatus may become large in size, making the configuration of the three-dimensional-object forming apparatus complicated. Also in this method for producing, in the configuration in which the solid object is removed off the transportable plate and then immersed in water to remove the support material, the three-dimensional object may be damaged at the time of removing the solid object off the transportable plate without using solvent such as water.

In light of the circumstances, it is an object of the present disclosure to provide such a method for producing a three-dimensional object that simplifies the configuration of a production apparatus or device to produce a three-dimensional object and eliminates or minimizes damage to the three-dimensional object during its production. It is also an object of the present disclosure to provide such an object that simplifies the configuration of a production apparatus or device to produce a three-dimensional object and eliminates or minimizes damage to the three-dimensional object during its production.

### SUMMARY

According to one aspect of the present disclosure, a method is for producing a three-dimensional object by extruding an ink onto an upper surface of a table using an ink-jet head and depositing an ink layer made of the ink over the upper surface of the table. The method includes: a removal portion forming step of depositing the ink layer over the upper surface of the table so as to form a removal portion with which the three-dimensional object is removed off the upper surface of the table; and an object forming step of depositing the ink layer over a planar upper surface of the removal portion formed in the removal portion forming step so as to form the three-dimensional object over the planar upper surface of the removal portion. The removal portion includes a support material and a mixture material. The support material supports the three-dimensional object. The mixture material is less adhesive to the upper surface of the table than the support material is adhesive to the upper surface of the table.

In one embodiment of the present disclosure, the ink layer constituting the removal portion includes a plurality of removal layers, and a first removal layer among the plurality of removal layers that is in contact with the upper surface of the table contains the mixture material.

According to another aspect of the present disclosure, an object is made of a cured ink having a three-dimensional shape formed on an upper surface of a table. The object includes a three-dimensional object and a removal portion with which the three-dimensional object is removed off the upper surface of the table. The three-dimensional object is located over the removal portion. The removal portion includes a support material and a mixture material. The support material supports the three-dimensional object. The mixture material is less adhesive to the upper surface of the table than the support material is adhesive to the upper surface of the table.

In one embodiment of the present disclosure, the ink layer constituting the removal portion includes a plurality of removal layers deposited upon each other, and a first removal layer among the plurality of removal layers that is in contact with the upper surface of the table contains the mixture material.

In one embodiment of the present disclosure, the removal portion with which the three-dimensional object is removed off the upper surface of the table contains: a support material to support the three-dimensional object; and a mixture material less adhesive to the upper surface of the table than the support material is adhesive to the upper surface of the table. Insofar as the mixture material is contained in the ink layer (removal layer) in contact with the upper surface of the table, the adhesive force between the upper surface of the table and the removal portion decreases. This configuration, as a result, facilitates the removal of the removal portion and the three-dimensional object off the upper surface of the table. Thus, in this embodiment of the present disclosure, it is not necessary to remove the transportable plate off the plate mount, which is necessary in the method for producing a three-dimensional object using the three-dimensional-object forming apparatus recited in JP2013-67016A1. This configuration simplifies the configuration of a production apparatus or device to produce a three-dimensional object. Also in this embodiment of the present disclosure, since the removal of the removal portion and the three-dimensional object off the upper surface of the table is facilitated, a reduced amount of force acts on the three-dimensional object when the removal portion and the three-dimensional object are removed off the upper surface of the table. Thus, this embodiment of the present disclosure eliminates or minimizes damage to the three-dimensional object during its production.

According to another aspect of the present disclosure, a method is for producing a three-dimensional object by extruding an ink onto an upper surface of a table using an ink-jet head and depositing an ink layer made of the ink over the upper surface of the table. The method includes: a removal portion forming step of depositing the ink layer over the upper surface of the table so as to form a removal portion with which the three-dimensional object is removed off the upper surface of the table; and an object forming step of depositing the ink layer over a planar upper surface of the removal portion formed in the removal portion forming step so as to form the three-dimensional object over the planar upper surface of the removal portion. The removal portion includes a support material and a mixture material. The support material supports the three-dimensional object. The mixture material is greater in hardness than the support material.

According to another aspect of the present disclosure, an object is made of a cured ink having a three-dimensional shape formed on an upper surface of a table. The object includes a three-dimensional object and a removal portion with which the three-dimensional object is removed off the upper surface of the table. The three-dimensional object is located over the removal portion. The removal portion includes a support material and a mixture material. The support material supports the three-dimensional object. The mixture material is greater in hardness than the support material.

In one embodiment of the present disclosure, the mixture material of the removal portion includes a plurality of mixture materials arranged in so close proximity to each other that a distortion occurring at one side of the removal portion in a direction approximately parallel to the upper surface of the table is transmitted to another side of the removal portion in the direction.

In one embodiment of the present disclosure, the removal portion with which the three-dimensional object is removed off the upper surface of the table contains: a support material to support the three-dimensional object; and a mixture material greater in hardness than the support material. Insofar as the mixture materials are arranged in so close proximity to each other that a distortion occurring at one side of the removal portion in a direction approximately parallel to the upper surface of the table is transmitted to another side of the removal portion in the direction, a distortion or a cut made at one side of a removal portion by inserting a paddle or a spatula between the upper surface of the table and the removal portion results in a distortion or a cut throughout the removal portion. This configuration, as a result, facilitates the removal of the removal portion and the three-dimensional object off the upper surface of the table. Thus, in this embodiment of the present disclosure, it is not necessary to remove the transportable plate off the plate mount, which is necessary in the method for producing a three-dimensional object using the three-dimensional-object forming apparatus recited in JP2013-67016A1. This configuration simplifies the configuration of a production apparatus or device to produce a three-dimensional object. Also in this embodiment of the present disclosure, since the removal of the removal portion and the three-dimensional object off the upper surface of the table is facilitated, a reduced amount of force acts on the three-dimensional object when the removal portion and the three-dimensional object are removed off the upper surface of the table. Thus, this embodiment of the present disclosure eliminates or minimizes damage to the three-dimensional object during its production.

In one embodiment of the present disclosure, the mixture material is preferably made of a model material identical to a model material constituting the three-dimensional object, and a second removal layer among the plurality of removal layers that is in contact with the three-dimensional object preferably contains the mixture material. With this configuration, the model material constituting the second removal layer in contact with the three-dimensional object and the model material constituting the three-dimensional object become integral to each other, increasing the adhesion between the removal portion and the three-dimensional object. As a result, when the three-dimensional object is formed by depositing ink layers over the upper surface of a removal portion, the three-dimensional object formed over the upper surface of the removal portion is kept in stabilized state.

In one embodiment of the present disclosure, the mixture material may be more adhesive to the three-dimensional object than the support material is adhesive to the three-dimensional object, and a second removal layer among the plurality of removal layers that is in contact with the three-dimensional object may contain the mixture material. In this case as well, the mixture material contained in the second removal layer in contact with the three-dimensional object increases the adhesion between the removal portion and the three-dimensional object. As a result, when the three-dimensional object is formed by depositing ink layers over the upper surface of a removal portion, the three-dimensional object formed over the upper surface of the removal portion is kept in stabilized state.

In one embodiment of the present disclosure, the ratio of the mixture material contained in the first removal layer in contact with the upper surface of the table is preferably higher than the ratio of the mixture material contained in the second removal layer in contact with the three-dimensional object. With this configuration, the ratio of the mixture material contained in the first removal layer in contact with the upper surface of the table is comparatively high. This effectively weakens the adhesive force between the upper surface of the table and the removal portion, and enables a large distortion to be made throughout the removal portion. This, as a result, further facilitates the removal of the removal portion and the three-dimensional object off the upper surface of the table. Also with the above configuration, the ratio of the mixture material contained in the second removal layer in contact with the three-dimensional object is comparatively low. This eliminates or minimizes excessive adhesion between the removal portion and the three-dimensional object, and eliminates or minimizes excessive increase of the adhesive force between the removal portion and the three-dimensional object. Thus, when the three-dimensional object is formed by depositing ink layers over the upper surface of a removal portion, the three-dimensional object formed over the upper surface of the removal portion is kept in stabilized state, while, after the three-dimensional object is formed, the removal portion is more easily removed off the three-dimensional object.

In one embodiment of the present disclosure, the ratio of the mixture material contained in each of the plurality of removal layers preferably becomes gradually lower in a direction from the first removal layer toward the second removal layer. This configuration eliminates such a situation in the removal portion that removal layers in which the mixture material is contained in largely different ratios are deposited upon each other. This eliminates or minimizes detachment of the removal layers from each other in the removal portion.

In one embodiment of the present disclosure, removal layers among the plurality of removal layers located between the first removal layer and the second removal layer may have identical ratios of the mixture material.

In one embodiment of the present disclosure, in a view of the removal portion from a vertical direction, the support material and the mixture material are arranged in a checkered pattern. In one embodiment of the present disclosure, in a view of the removal portion from a horizontal direction, each of the support material and the mixture material is arranged to form a column shape.

Thus, the embodiments of the present disclosure simplify the configuration of a production apparatus or device to produce a three-dimensional object, and eliminate or minimize damage to the three-dimensional object during its production.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 illustrates a method according to an embodiment of the present disclosure for producing a three-dimensional object;

FIG. 2 is a graph showing ratios of the mixture material contained in the removal layers illustrated in FIG. 1;

FIG. 3 is a graph according to a modification showing ratios of the mixture material contained in the removal layers illustrated in FIG. 1;

FIG. 4 is a graph according to a modification showing ratios of the mixture material contained in the removal layers illustrated in FIG. 1;

FIG. 5 illustrates an exemplary state of a removal portion illustrated in FIG. 1 viewed from a vertical direction; and

FIG. 6 illustrates an exemplary state of a removal portion illustrated in FIG. 1 viewed from a horizontal direction.

### DESCRIPTION OF THE EMBODIMENTS

The embodiments will now be described with reference to the accompanying drawings, wherein like reference numerals designate corresponding or identical elements throughout the various drawings.

### Method for Producing a Three-Dimensional Object

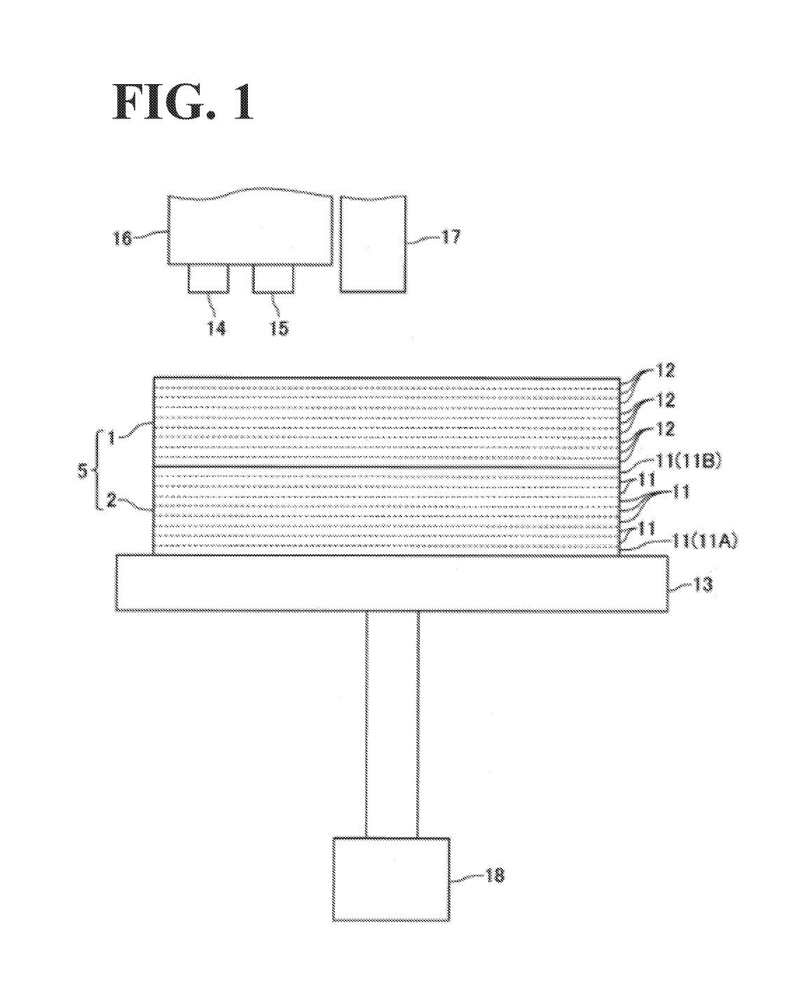

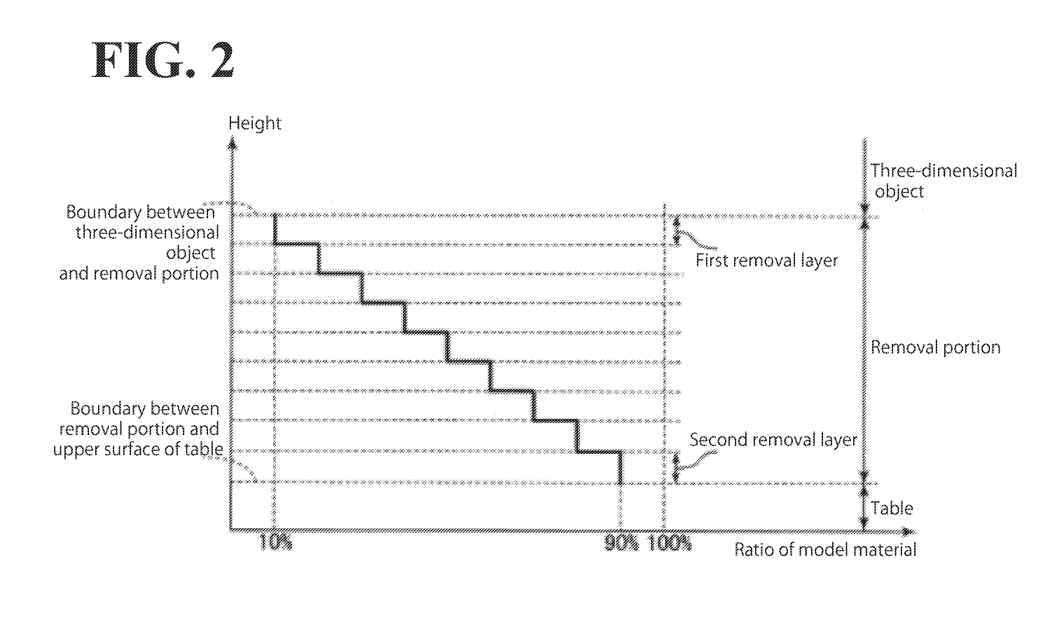

FIG. 1 illustrates a method according to an embodiment of the present disclosure for producing a three-dimensional object. FIG. 2 is a graph showing ratios of the mixture material contained in the removal layers 11 illustrated in FIG. 1.

In the method according to this embodiment for producing a three-dimensional object, the ink-jet heads 14 and 15 extrude ink onto the upper surface of a table 13 so as to deposit ink layers 11 and 12, which are made of the ink and constitute a three-dimensional object 1. This method for producing includes: a removal portion forming step of depositing the ink layer 11 over the upper surface of the table 13 so as to form a removal portion 2, with which the three-dimensional object 1 is removed off the upper surface of the table 13; after the removal portion forming step, an object forming step of depositing the ink layer 12 over a planar upper surface of the removal portion 2 formed in the removal portion forming step so as to form the three-dimensional object 1; and after the object forming step, a removal portion removing step of removing the removal portion 2.

The three-dimensional object 1 is made of a model material, which is a forming-purpose ink. The removal portion 2 has a function to support the three-dimensional object 1, and includes: a support material to support the three-dimensional object 1; and a mixture material less adhesive to the upper surface of the table 13 than the support material is adhesive to the upper surface of the table 13 (that is, the mixture material has a lower adhesive force than the support material). Thus, the removal portion 2 contains a support material and a mixture material. The mixture material according to this embodiment is a model material identical to the model material constituting the three-dimensional object 1. The ink layer 11 constituting the removal portion 2 includes a plurality of ink layers 11, which will be referred to as “removal layers 11”. Among the plurality of removal layers 11, the removal layer 11 that is in contact with the upper surface of the table 13 will be referred to as “first removal layer 11A”, and the removal layer 11 that is in contact with the three-dimensional object 1 will be referred to as “second removal layer 11B”. Each of the first removal layer 11A and the second removal layer 11B is made up of the support material and the model material. That is, the first removal layer 11A and the second removal layer 11B contain the model material.

In this embodiment, the ratio of the model material contained in the first removal layer 11A is higher than the ratio of the model material contained in the second removal layer 11B. For example, the ratio of the model material contained in the first removal layer 11A (volume of model material/(volume of model material+volume of support material)×100 (or (weight of model material)/(weight of model material+weight of support material)×100)) is 90%, while the ratio of the model material contained in the second removal layer 11B is 10%. Also in this embodiment, as illustrated in FIG. 2, the ratio of the model material contained in each of the removal layers 11 becomes gradually lower in the direction from the first removal layer 11A toward the second removal layer 11B. Specifically, the ratio of the model material contained in one removal layer 11 is lower by a constant rate than the ratio of the model material contained in another removal layer 11 that is closer to the first removal layer 11A than the one removal layer 11 is to the first removal layer 11A.

The ink-jet head 14 extrudes the model material (forming-purpose ink) constituting the three-dimensional object 1 and part of the removal portion 2. The ink-jet head 15 extrudes the support material (support-purpose ink) constituting part of the removal portion 2. In the following description, the ink-jet head 14 will be referred to as “model material extruder 14”, and the ink-jet head 15 will be referred to as “support material extruder 15”. The ink extruded from the model material extruder 14 is an active energy line curable ink. Specifically, the ink is an ultraviolet curable ink, which cures under ultraviolet light. The ink extruded from the support material extruder 15 is an active energy line curable ink, too. Specifically, the ink is an ultraviolet curable ink. The ink extruded from the support material extruder 15 also has such a solubility that the ink is dissolvable in a predetermined solvent. Specifically, the ink is a water soluble ink, which is dissolvable in water as solvent. Thus, the removal portion 2 is partially made of a water soluble ink.

The model material extruder 14 and the support material extruder 15 is incorporated in a carriage 16, which is located above the table 13. Also above the table 13, an ultraviolet radiator 17 is located. The ultraviolet radiator 17 radiates ultraviolet light. While being scanned independently or together with the model material extruder 14 and the support material extruder 15, the ultraviolet radiator 17 radiates ultraviolet light to the inks extruded from the model material extruder 14 and the support material extruder 15. It is also possible for the ultraviolet radiator 17 to radiate ultraviolet light to the upper surface of the table 13 as a whole. The ultraviolet radiator 17 illustrated in FIG. 1 is a scannable radiator. To the table 13, an elevating mechanism 18 is connected. The elevating mechanism 18 lifts the table 13 upward and downward. Thus, the elevating mechanism 18 is perpendicular driving means for changing the position in the height direction of the upper surface of the table 13 relative to the model material extruder 14 and the support material extruder 15. The upper surface of the table 13 is planar shaped and is alumited.

In the removal portion forming step, first, the model material extruder 14 and the support material extruder 15 extrude the inks for the first removal layer 11A onto the upper surface of the table 13. Specifically, the model material extruder 14 extrudes ink based on the ratio of the model material contained in the first removal layer 11A, and the support material extruder 15 extrudes ink based on the ratio of the support material contained in the first removal layer 11A. Then, the ultraviolet radiator 17 radiates ultraviolet light to the extruded ink to completely cure or semi-cure the ink, thereby forming the first removal layer 11A. After the first removal layer 11A is formed, the table 13 moves downward over a height corresponding to the thickness of the first removal layer 11A. After the table 13 has moved downward, the model material extruder 14 and the support material extruder 15 similarly extrude inks for the next removal layer 11, and the ultraviolet radiator 17 radiates ultraviolet light to the extruded ink to completely cure or semi-cure the ink, thereby forming the next removal layer 11.

Thus, in the removal portion forming step, ink extrusion, curing (complete curing or semi-curing) of the extruded ink, and downward movement of the table 13 are repeated to form the removal portion 2. After the removal portion forming step, the upper surface of the removal portion 2 is planar shaped, not bent or distorted. The removal portion 2 also serves as a foundation on which the three-dimensional object 1 is supported. That is, the removal portion 2 is a foundation layer on which the three-dimensional object 1 is formed.

In the object forming step, which is after the removal portion forming step, first, the model material extruder 14 extrudes ink for one ink layer 12 onto the upper surface of the removal portion 2. Then, the ultraviolet radiator 17 radiates ultraviolet light to the extruded ink to completely cure or semi-cure the ink, thereby forming the one ink layer 12. After the one ink layer 12 is formed, the table 13 moves downward over a height corresponding to the thickness of the ink layer 12. After the table 13 has moved downward, the model material extruder 14 similarly extrudes the ink for the next ink layer 12, and the ultraviolet radiator 17 radiates ultraviolet light to the extruded ink to completely cure or semi-cure the ink, thereby forming the next ink layer 12. Thus, in the object forming step, ink extrusion, curing (complete curing or semi-curing) of the extruded ink, and downward movement of the table 13 are repeated to form the three-dimensional object 1.

After the object forming step has ended, an object 5 is obtained. The object 5 is made up of the three-dimensional object 1 and the removal portion 2. Specifically, the object 5 is a three-dimensional object made of the inks cured over the upper surface of the table 13. In the object 5, the three-dimensional object 1 is located over the removal portion 2. Also in the object 5, the removal portion 2 is made up of the plurality of removal layers 11 deposited upon each other.

In the removal portion removing step, which is after the object forming step, first, the three-dimensional object 1 and the removal portion 2 (that is, the object 5) are removed off the table 13. Specifically, the object 5 is separated from the table 13 at the boundary between the upper surface of the table 13 and the first removal layer 11A. Then, the removal portion 2 is removed. As described above, part of the removal portion 2 is made of a water soluble ink. In the removal portion removing step, therefore, the object 5 removed off the table 13 is immersed in water to dissolve the part of the removal portion 2 in water, thereby removing the removal portion 2. With the removal portion 2 removed, the three-dimensional object 1 is complete.

### Advantageous Effects of this Embodiment

As has been described hereinbefore, in this embodiment, the first removal layer 11A, which is in contact with the upper surface of the table 13, contains a model material less adhesive to the upper surface of the table 13 than the support material is adhesive to the upper surface of the table 13. This configuration of the embodiment decreases the adhesive force between the upper surface of the table 13 and the removal portion 2, facilitating the removal of, in the removal portion removing step, the three-dimensional object 1 and the removal portion 2 off the upper surface of the table 13. Thus, in this embodiment, it is not necessary to remove the transportable plate off the plate mount, which is necessary in the method for producing a three-dimensional object using the three-dimensional-object forming apparatus recited in JP2013-67016A1. This configuration simplifies the configuration of a production apparatus or device to produce a three-dimensional object 1. Also in this embodiment, since the removal of the three-dimensional object 1 and the removal portion 2 oft the upper surface of the table 13 is facilitated, a reduced amount of force acts on the three-dimensional object 1 when the three-dimensional object 1 and the removal portion 2 are removed off the upper surface of the table 13 in the removal portion removing step. Thus, this embodiment eliminates or minimizes damage to the three-dimensional object 1 in the removal portion removing step.

In this embodiment, the second removal layer 11B, which is in contact with the three-dimensional object 1, contains a model material. This configuration of the embodiment increases the adhesion between the three-dimensional object 1 and the removal portion 2. As a result, in this embodiment, when the three-dimensional object 1 is formed by depositing the ink layer 12 over the upper surface of the removal portion 2 in the object forming step, the three-dimensional object 1 formed over the upper surface of the removal portion 2 is kept in stabilized state.

In this embodiment, the ratio of the model material contained in the first removal layer 11A is higher than the ratio of the model material contained in the second removal layer 11B. For example, the ratio of the model material contained in the first removal layer 11A is 90%. This configuration of the embodiment effectively weakens the adhesive force between the upper surface of the table 13 and the removal portion 2. This, as a result, further facilitates the removal of the three-dimensional object 1 and the removal portion 2 off the upper surface of the table 13 in the removal portion removing step. Also in this embodiment, the ratio of the model material contained in the second removal layer 11B is lower than the ratio of the model material contained in the first removal layer 11A. For example, the ratio of the model material contained in the second removal layer 11B is 10%. This configuration of the embodiment eliminates or minimizes excessive adhesion between the three-dimensional object 1 and the removal portion 2. Thus, in this embodiment, in the object forming step, the three-dimensional object 1 formed over the upper surface of the removal portion 2 is kept in stabilized state, while, in the removal portion removing step, the removal portion 2 is more easily removed off the three-dimensional object 1.

In this embodiment, the ratio of the model material contained in each of the removal layers 11 becomes gradually lower in the direction from the first removal layer 11A toward the second removal layer 11B. This configuration of the embodiment eliminates such a situation in the removal portion 2 that removal layers 11 in which the mixture material is contained in largely different ratios are deposited upon each other. This eliminates or minimizes detachment of the removal layers 11 from each other in the removal portion 2.

### Modifications of the Removal Portion

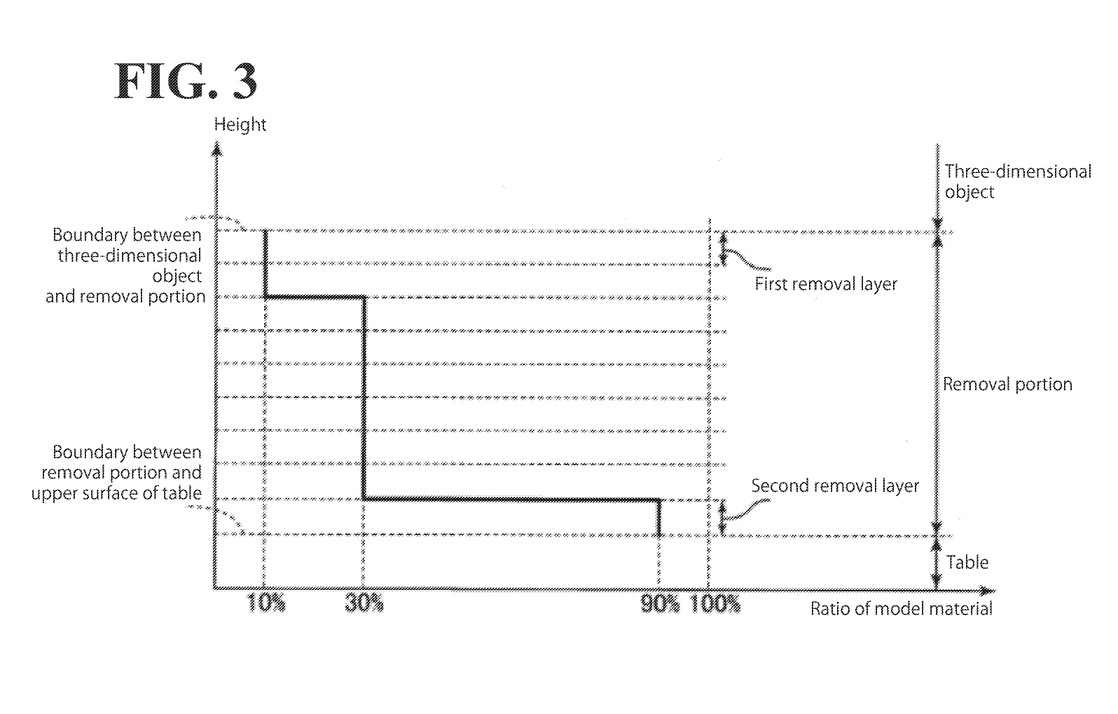

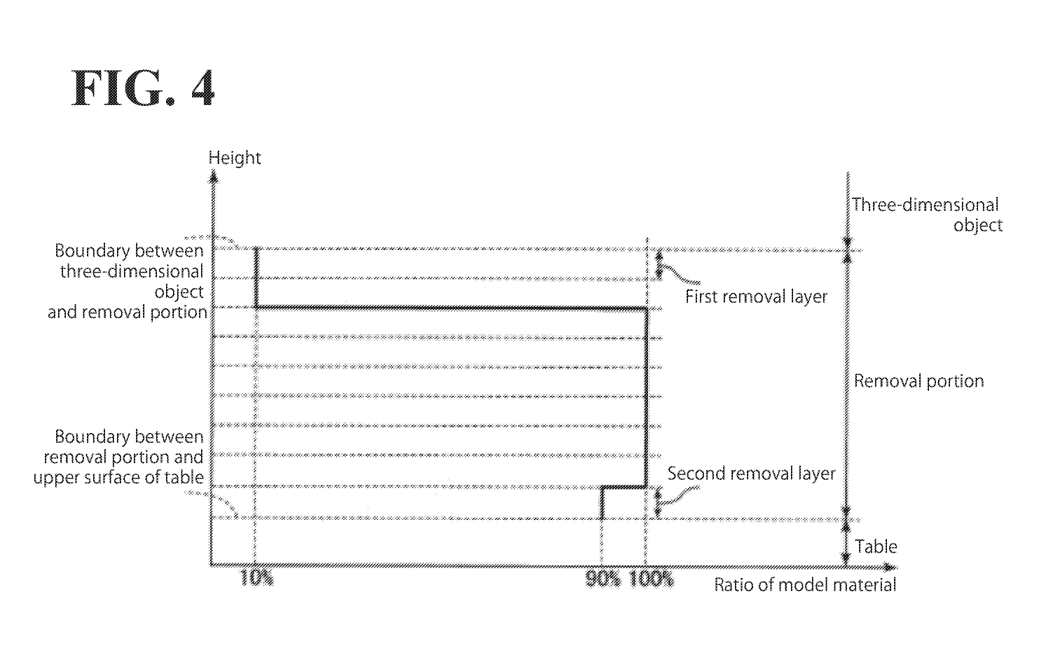

FIGS. 3 and 4 are graphs according to modifications showing ratios of the mixture material contained in the removal layers illustrated in FIG. 1.

In the above-described embodiment, the ratio of the model material contained in each of the removal layers 11 becomes gradually lower in the direction from the first removal layer 11A toward the second removal layer 11B. In a possible modification, a plurality of removal layers 11 having the same model material ratio (content) may be provided between the first removal layer 11A and the second removal layer 11B. Specifically, as illustrated in FIG. 3, a plurality of removal layers 11 each having a model material ratio lower than the ratio of the model material contained in the first removal layer 11A and higher than the ratio of the model material contained in the second removal layer 11B (for example, a plurality of removal layers 11 each having a 30% model material ratio) may be provided between the first removal layer 11A and the second removal layer 11B. As illustrated in FIG. 4, a plurality of removal layers 11 each having a model material ratio higher than the ratio of the model material contained in the first removal layer 11A (for example, a plurality of removal layers 11 each having a 100% model material ratio) may be provided between the first removal layer 11A and the second removal layer 11B. Also, a plurality of removal layers 11 each having a model material ratio lower than the ratio of the model material contained in the second removal layer 11B (for example, a plurality of removal layers 11 each having a 0% model material ratio) may be provided between the first removal layer 11A and the second removal layer 11B.

Also as illustrated in FIGS. 3 and 4, a removal layer 11 having the same model material ratio as the model material ratio in the second removal layer 11B may be superimposed on the second removal layer 11B. Similarly, a removal layer 11 having the same model material ratio as the model material ratio in the first removal layer 11A may be superimposed on the first removal layer 11A. Also in the above-described embodiment, the second removal layer 11B contains a model material. The second removal layer 11B, however, may not necessarily contain a model material. Also in the above-described embodiment, the first removal layer 11A contains a support material. The first removal layer 11A, however, may not necessarily contain a support material. Specifically, the ratio of the model material contained in the first removal layer 11A may be 100%. Also in the above-described embodiment, the ratio of the model material contained in the first removal layer 11A is higher than the ratio of the model material contained in the second removal layer 11B. In a possible modification, the ratio of the model material contained in the first removal layer 11A may be equivalent to or less than the ratio of the model material contained in the second removal layer 11B. Also in the above-described embodiment, the removal portion 2 is made up of a model material and a support material. In a possible modification, the removal portion 2 may contain an additional material, as well as the model material and the support material.

### Other Embodiments

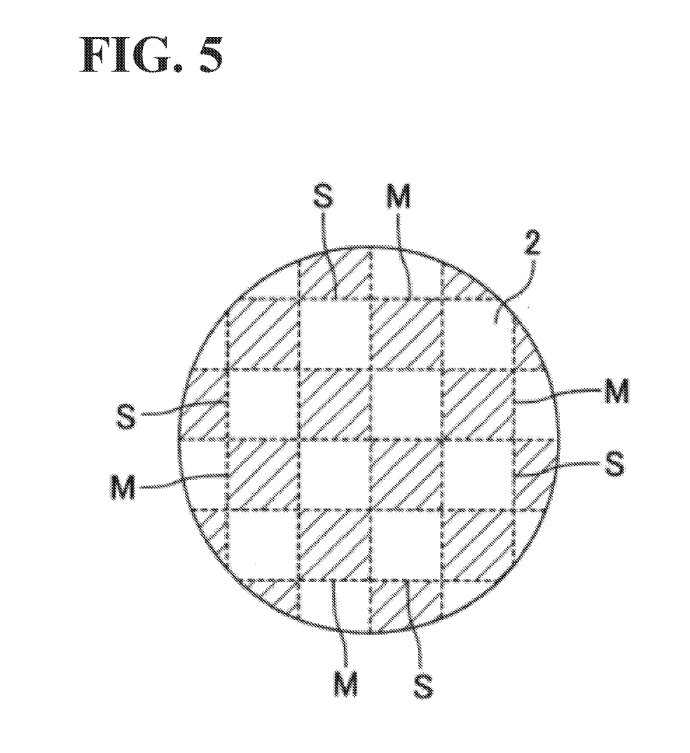

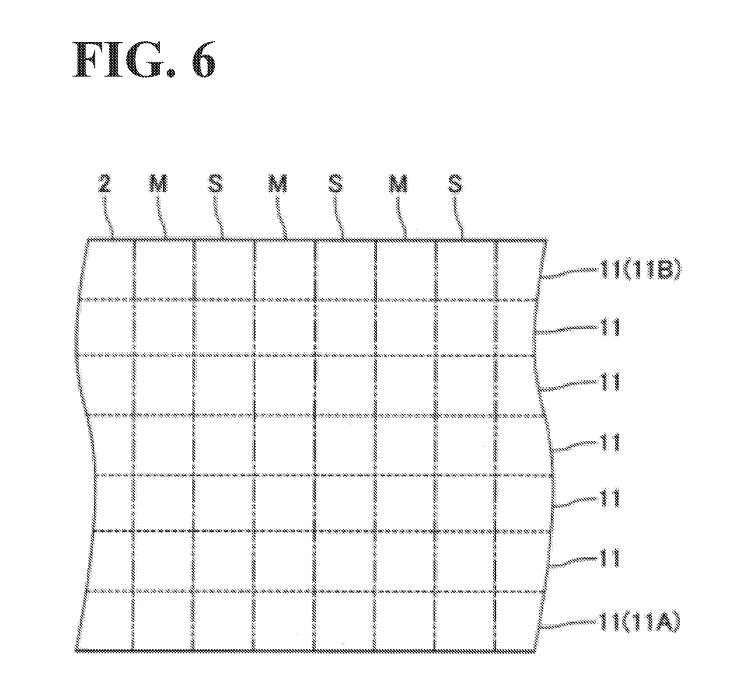

In the above-described embodiment, in a view of the removal portion 2 from a vertical direction, support materials S and model materials M may be arranged in a checkered pattern, as illustrated in FIG. 5. Also in the above-described embodiment, in a view of the removal portion 2 from a horizontal direction, the support materials S and the model materials M may be arranged to form a column shape, as illustrated in FIG. 6.

In the above-described embodiment, the mixture material contained in the removal portion 2 is a model material identical to the model material constituting the three-dimensional object 1. In another possible embodiment, the mixture material contained in the removal portion 2 may be other than this model material. In this case, the mixture material is preferably more adhesive to the three-dimensional object 1 than the support material is adhesive to the three-dimensional object 1, and the second removal layer 11B preferably contains this mixture material. This increases the adhesion between the three-dimensional object 1 and the removal portion 2. As a result, similarly to the above-described embodiment, when the three-dimensional object 1 is formed by depositing the ink layers 12 over the upper surface of the removal portion 2 in the object forming step, the three-dimensional object 1 formed over the upper surface of the removal portion 2 is kept in stabilized state. The adhesion of the mixture material with respect to the three-dimensional object 1 may be approximately equal to the adhesion of the support material with respect to the three-dimensional object 1, or may be lower than the adhesion of the support material with respect to the three-dimensional object 1.

In the above-described embodiment, the support material (support-purpose ink) is a water soluble ink. In another possible embodiment, the support material may be an ink dissolvable in a solvent other than water (for example, organic solvent). Also in the above-described embodiment, the support material is an ultraviolet curable ink. In another possible embodiment, the support material may be other than an ultraviolet curable ink insofar as the support material can be extruded from the support material extruder 15 and capable of removing the removal portion 2 in the removal portion removing step.

In the above-described embodiment, the mixture material contained in the removal portion 2 is less adhesive to the upper surface of the table 13 than the support material contained in the removal portion 2 is adhesive to the upper surface of the table 13. In another possible embodiment, the mixture material contained in the removal portion 2 and the support material contained in the removal portion 2 may be equally adhesive to the upper surface of the table 13, or the mixture material contained in the removal portion 2 may be more adhesive to the upper surface of the table 13 than the support material contained in the removal portion 2 is adhesive to the upper surface of the table 13. In this case, the mixture material contained in the removal portion 2 is greater in hardness than the support material contained in the removal portion 2. Also in this case, the mixture materials of the removal portion 2 are arranged in so close proximity to each other that a distortion occurring at one side of the removal portion 2 (for example, right side of FIG. 1) in a direction approximately parallel to the upper surface of the table 13 is transmitted to another side of the removal portion 2 (for example, left side of FIG. 1).

In this case, a distortion or a cut made at one side of the removal portion 2 by inserting a paddle or a spatula between the upper surface of the table 13 and the removal portion 2 results in a distortion or a cut throughout the removal portion 2. This configuration, as a result, facilitates the removal of the removal portion 2 and the three-dimensional object 1 off the upper surface of the table 13. Thus, it is not necessary to remove the transportable plate off the plate mount, which is necessary in the method for producing a three-dimensional object using the three-dimensional-object forming apparatus recited in JP2013-67016A1. This configuration simplifies the configuration of a production apparatus or device to produce a three-dimensional object 1. Since the removal of the removal portion 2 and the three-dimensional object 1 off the upper surface of the table 13 is facilitated, a reduced amount of force acts on the three-dimensional object 1 when the three-dimensional object 1 and the removal portion 2 are removed off the upper surface of the table 13. This eliminates or minimizes damage to the three-dimensional object 1 in the removal portion removing step.

It is also possible that the mixture material contained in the removal portion 2 is less adhesive to the upper surface of the table 13 than the support material contained in the removal portion 2 is adhesive to the upper surface of the table 13, while at the same time the mixture material contained in the removal portion 2 is greater in hardness than the support material contained in the removal portion 2. In this case, for example, the mixture material is a model material identical to the model material constituting the three-dimensional object 1.
1 Three-dimensional object
2 Removal portion
5 Object
11 Ink layer (removal layer)
11A First removal layer
11B Second removal layer
12 Ink layer
13 Table
14 Model material extruder (ink-jet head)
15 Support material extruder (ink-jet head)

What is claimed is:

1. A method for producing a three-dimensional object by extruding an ink onto an upper surface of a table using an ink-jet head and depositing an ink layer made of the ink over the upper surface of the table, the method comprising:
a removal portion forming step of depositing the ink layer over the upper surface of the table so as to form a removal portion with which the three-dimensional object is removed off the upper surface of the table; and
an object forming step of depositing the ink layer over a planar upper surface of the removal portion formed in the removal portion forming step so as to form the three-dimensional object over the planar upper surface of the removal portion,
wherein the removal portion comprises
a support material to support the three-dimensional object, and
a mixture material less adhesive to the upper surface of the table than the support material is adhesive to the upper surface of the table.

2. A method for producing a three-dimensional object by extruding an ink onto an upper surface of a table using an ink-jet head and depositing an ink layer made of the ink over the upper surface of the table, the method comprising:
a removal portion forming step of depositing the ink layer over the upper surface of the table so as to form a removal portion with which the three-dimensional object is removed off the upper surface of the table; and
an object forming step of depositing the ink layer over a planar upper surface of the removal portion formed in the removal portion forming step so as to form the three-dimensional object over the planar upper surface of the removal portion,
wherein the removal portion comprises
a support material to support the three-dimensional object, and
a mixture material greater in hardness than the support material.

3. The method according to claim 2, wherein the mixture material of the removal portion comprises a plurality of mixture materials arranged in so close proximity to each other that a distortion occurring at one side of the removal portion in a direction approximately parallel to the upper surface of the table is transmitted to another side of the removal portion in the direction.

4. The method according to claim 1,
wherein the ink layer constituting the removal portion comprises a plurality of removal layers, and
wherein a first removal layer among the plurality of removal layers that is in contact with the upper surface of the table comprises the mixture material.

5. The method according to claim 4,
wherein the mixture material comprises a model material identical to a model material constituting the three-dimensional object, and
wherein a second removal layer among the plurality of removal layers that is in contact with the three-dimensional object comprises the mixture material.

6. The method according to claim 4,
wherein the mixture material is more adhesive to the three-dimensional object than the support material is adhesive to the three-dimensional object, and
wherein a second removal layer among the plurality of removal layers that is in contact with the three-dimensional object comprises the mixture material.

7. The method according to claim 5, wherein a ratio of the mixture material contained in the first removal layer in contact with the upper surface of the table is higher than a ratio of the mixture material contained in the second removal layer in contact with the three-dimensional object.

8. The method according to claim 7, wherein a ratio of the mixture material contained in each of the plurality of removal layers becomes gradually lower in a direction from the first removal layer toward the second removal layer.

9. The method according to claim 7, wherein removal layers among the plurality of removal layers located between the first removal layer and the second removal layer have identical ratios of the mixture material.

10. The method according to claim 1, wherein in a view of the removal portion from a vertical direction, the support material and the mixture material are arranged in a checkered pattern.

11. The method according to claim 1, wherein in a view of the removal portion from a horizontal direction, each of the support material and the mixture material is arranged to form a column shape.

12. An object made of a cured ink having a three-dimensional shape formed on an upper surface of a table, the object comprising:
a three-dimensional object; and
a removal portion with which the three-dimensional object is removed off the upper surface of the table,
wherein the three-dimensional object is located over the removal portion, and
wherein the removal portion comprises
a support material to support the three-dimensional object, and
a mixture material less adhesive to the upper surface of the table than the support material is adhesive to the upper surface of the table.

13. An object made of a cured ink having a three-dimensional shape formed on an upper surface of a table, the object comprising:
a three-dimensional object; and
a removal portion with which the three-dimensional object is removed off the upper surface of the table,
wherein the three-dimensional object is located over the removal portion, and
wherein the removal portion comprises
a support material to support the three-dimensional object, and
a mixture material greater in hardness than the support material.

14. The object according to claim 13, wherein the mixture material of the removal portion comprises a plurality of mixture materials arranged in so close proximity to each other that a distortion occurring at one side of the removal portion in a direction approximately parallel to the upper surface of the table is transmitted to another side of the removal portion in the direction.

15. The object according to claim 12,
wherein the ink layer constituting the removal portion comprises a plurality of removal layers deposited upon each other, and
wherein a first removal layer among the plurality of removal layers that is in contact with the upper surface of the table comprises the mixture material.

16. The object according to claim 15,
wherein the mixture material comprises a model material identical to a model material constituting the three-dimensional object, and
wherein a second removal layer among the plurality of removal layers that is in contact with the three-dimensional object comprises the mixture material.

17. The object according to claim 15,
wherein the mixture material is more adhesive to the three-dimensional object than the support material is adhesive to the three-dimensional object, and
wherein a second removal layer among the plurality of removal layers that is in contact with the three-dimensional object comprises the mixture material.

18. The object according to claim 16, wherein a ratio of the mixture material contained in the first removal layer in contact with the upper surface of the table is higher than a ratio of the mixture material contained in the second removal layer in contact with the three-dimensional object.

19. The method according to claim 2,
wherein the ink layer constituting the removal portion comprises a plurality of removal layers, and
wherein a first removal layer among the plurality of removal layers that is in contact with the upper surface of the table comprises the mixture material.

20. The method according to claim 3,
wherein the ink layer constituting the removal portion comprises a plurality of removal layers, and
wherein a first removal layer among the plurality of removal layers that is in contact with the upper surface of the table comprises the mixture material.
